(19) United States
(12) Patent Application Publication
(10) Pub. No.: US 2011/0032219 A1
(43) Pub. Date: Feb. 10, 2011

(54) LEVER SWITCH WITH DISPLAY DEVICE

(75) Inventors: Masahiro Aoyama, Kawasaki-shi (JP); Isao Okayasu, Kawasaki-shi (JP); Seiji Noguchi, Kawasaki-shi (JP); Toshio Hayashi, Kawasaki-shi (JP); Hitomi Yamaga, Kawasaki-shi (JP); Lee Pistor, Scottsdale, AZ (US); Gary Wilson, Scottsdale, AZ (US); Jani Duffy, Scottsdale, AZ (US); Matt Heider, Scottsdale, AZ (US); Matt Minton, Scottsdale, AZ (US); Jorge Mendivil, Scottsdale, AZ (US)

Correspondence Address: BACON & THOMAS, PLLC, 625 SLATERS LANE, FOURTH FLOOR, ALEXANDRIA, VA, 22314-1176, US

(73) Assignee: NIHON KAIHEIKI INDUSTRIAL COMPANY, LTD., Kawasaki-shi (JP)

(21) Appl. No.: 12/723,866

(22) Filed: Mar. 15, 2010

(30) Foreign Application Priority Data
Aug. 4, 2009 (JP) 2009-181138

(51) Int. Cl. G06F 3/033

(52) U.S. Cl. 345/184

(57) ABSTRACT

The present invention is directed to provide a lever switch with a display device that is variably displayable of pictures or texts.

A lever 18 is configured by disposing an organic light-emitting device 10 in a manner that it is interposed between an operating unit 1 and an operating unit cover 13 and coupling a shaft 14 to the operating unit 1, and a housing 19 is fitted with a bezel 24 so that the lever 18 protrudes from a hole for tilting 24a of the bezel 24, thereby the lever 18 is tiltably disposed. In the housing 19, a printed circuit board 20 is arranged with a photo-interrupter 23 implemented thereon for detecting a tilting motion of the lever 18.

### BACKGROUND OF THE INVENTION

1. Field of the Invention

The present invention relates to a lever switch with a display device, and a lever switch with a display device in a lever.

2. Description of the related art

As conventional lever switches, there have been those comprising a light source inside a spherical grip (see Patent Document I listed below).

[Patent Document 1] JP 2008-154864 A

However, the conventional lever switches mentioned above were to inform an operator of a change in aspect with a visible change of light by switching on/off a light source disposed therein, and thus could not display pictures or texts that are variably displayable. In addition, a display device was provided separately from the lever switch when displaying is required, so that miniaturization of the device has been difficult.

In view of the above situations, the present invention is directed to provide a lever switch with a display device that is variably displayable of pictures or texts.

### SUMMARY OF THE INVENTION

In order to achieve the object described above, the present invention provides the following:
A lever switch including a lever tiltably disposed in a housing and detection means for detecting a tilting motion of the lever arranged in the housing, characterized in that the lever is provided with a display unit and a display device is provided below the display unit.
It is characterized in that the display device is an organic light-emitting device.
It is characterized in that display of the display unit changes along with the tilting motion of the lever.
It is characterized in that the display unit is disposed in the lever via a resilient member, the display unit is allowed for a pressing operation, and a contact mechanism operated along with the pressing operation is disposed below the display device.
It is characterized in that display of the display unit changes along with a pressing motion of the display unit.
It is characterized in that the lever is disposed in the housing in a manner that a tilting shaft is movable in the vertical direction, the lever as a whole is allowed for the pressing operation, and the contact mechanism operated along with the pressing operation is disposed in the lower part of the housing.
It is characterized in that display of the display unit changes along with the pressing motion of the lever.

The present invention can provide the following effects.

(1) Since a display device is provided in a lever, various displays are made possible, resulting in the improvement of visibility.
(2) Since the display device is provided in the lever, display can be changed along with an operation of the lever.
(3) Since the display device is provided in the lever, miniaturization of the device can be realized.

### BRIEF DESCRIPTION OF THE DRAWINGS

FIG. 1 is a perspective view of a lever switch with a display device showing a first embodiment of the present invention;

FIG. 2 is an exploded perspective view of the lever switch with the display device showing the first embodiment of the present invention;

FIG. 3 is a cross-sectional view of the lever switch with the display device showing the first embodiment of the present invention;

FIG. 4 is a cross-sectional view of a main part of the lever switch with the display device in a tilted position showing the first embodiment of the present invention; and

FIG. 5 is a cross-sectional view of a main part of the lever switch with the display device showing a second embodiment of the present invention.

### DESCRIPTION OF THE PREFERRED EMBODIMENTS

The present invention is configured to have a lever tiltably disposed that is provided with a display device. Thus, the lever switch per se is allowed to realize various displays and improve the visibility.

### Embodiments

Hereinbelow, the embodiments of the present invention will be described in detail with reference to the drawings.

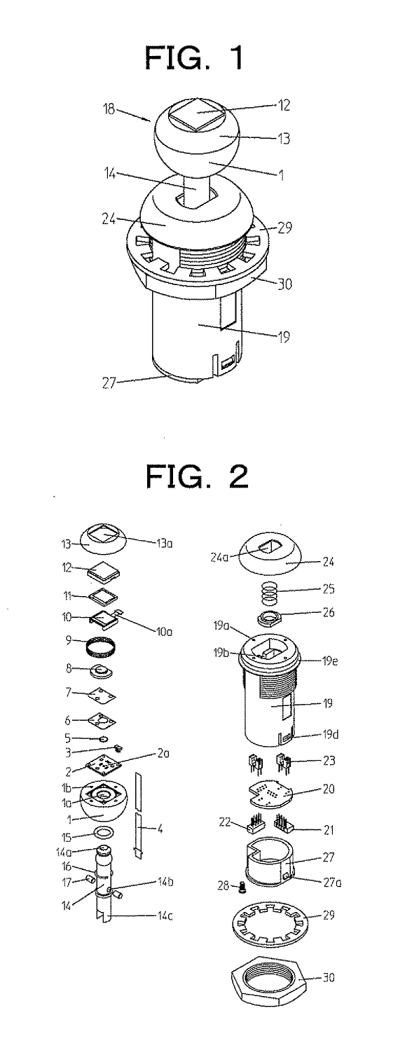

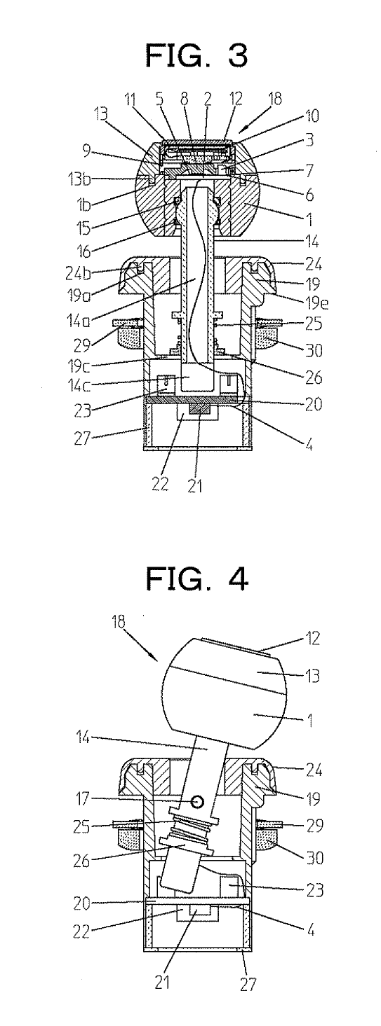

FIG. 1 is a perspective view of a lever switch with a display device showing a first embodiment of the present invention, FIG. 2 is an exploded perspective view thereof, FIG. 3 is a cross-sectional view thereof, and FIG. 4 is a cross-sectional view of a main part thereof.

In these figures, reference numeral 1 denotes an operating unit, 2 a printed circuit board disposed in the operating unit 1, 3 a connector implemented on the printed circuit board 2, 4 a flexible printed circuit board implemented on the printed circuit board, 5 a movable contactor disposed on the printed circuit board 2, 6 a spacer disposed on the printed circuit board 2, 7 a presser sheet disposed on the spacer 6, 8 a rubber cover disposed on the presser sheet 7, 9 a coil spring disposed on the operating unit 1, 10 an organic light-emitting device (OLED) disposed on the coil spring 9, 11 a spacer disposed on the OLED 11, 12 a display unit disposed on the spacer 11, 13 an operating unit cover fitted over the operating unit 1, 14 a shaft, 15 an O-ring interposed between the operating unit 1 and the shaft 14, 16 a stop ring fitted with the operating unit 1 to couple the shaft 14 so as to prevent it from falling out of the operating unit 1, and 17 a tilting shaft fitted in the shaft 14 and acting as a supporting point of tilting.

The printed circuit board 2 with the connector 2 and the flexible printed circuit board 4 implemented thereon is disposed on the operating unit 1, while the flexible printed circuit board 4 is inserted through a through hole la of the operating unit 1 to protrude downward therefrom. The movable contactor 5, the spacer 6, the presser sheet 7, and the rubber cover 8 are disposed on the printed circuit board 2 to configure a contact mechanism. The coil spring 9 is disposed on the operating unit 1, the OLED 10 is disposed on the coil spring 9 while a flexible printed circuit board 10a is connected to the connector 3, the display unit 12 is disposed on the OLED 10 via the spacer 11, the operating unit cover 13 covers the display unit 12 in a manner that the top surface of the display unit 12 protrudes from a display opening 13a, and a fitting protrusion 13b is fitted with a fitting concave lb of the operating unit 1. The shaft 14 is formed as a hollow body, in which the flexible printed circuit board 4 is inserted through a hollow section 14a to protrude downward therefrom, and an upper part thereof is inserted into the through hole la of the operating unit 1. At this point, the O-ring 15 is clamped between the operating unit 1 and the shaft 4 while the stop ring 16 is fitted with the operating unit 1, so that the operating unit 1 and the shaft 14 are coupled together. Then, the tilting shaft 17 is fitted in a fitting concave 14b, and thereby a lever 18 is configured.

The reference numeral 19 denotes a housing formed in a generally tubular shape, 20 a printed circuit board arranged in the housing 19, 21 and 22 connectors implemented on the printed circuit board 20, 23 a photo-interrupter implemented on the printed circuit board 20 for detecting a tilting motion of the lever 18, 24 a bezel, 25 a coil spring, 26 a sleeve, 27 a housing cover, 28 a screw for securing the housing 19 and the housing cover 27, 29 a washer, and 30 a nut.

For the housing 19, a fitting concave 19a to be fitted with a fitting protrusion 24b of the bezel 24 is formed on the top surface, a bearing section 19b for supporting the tilting shaft 17 and a partition section 19c for disposing the sleeve 26 thereon are formed inside, and a fitting hole 19d for fitting with a fitting concave 27a of the housing cover 27 is formed in the lower part. For the printed circuit board 20, the connector 21 for connecting with the flexible printed circuit board 4 as well as the connector 22 and the photo-interrupter 23 for connecting with external components are implemented.

The lever 18 is inserted into a hole for tilting 24a of the bezel 24 from above, and the flexible printed circuit board 4 protruding from the bottom of the shaft 14 is inserted through the housing 19 and connected to the connector 21. At this point, the coil spring 25 and the sleeve 26 are slidably mounted on the shaft 14. The fitting protrusion 24b is fitted in the fitting concave 19a so that the bezel 24 is fitted to the housing, and the tilting shaft 17 is tiltably interposed between the housing 19 and the bezel 24 so that the lever 18 is disposed in the housing 19. At this point, the sleeve 26 is disposed on the partition section 19c, and the coil spring 25 is disposed on the sleeve 26. By disposing the printed circuit board 20 from the bottom of the housing 19, installing the housing cover 27 from the bottom of the housing 19, and fitting the fitting convex 27a in the fitting hole 19d while screwing with a screw 28, the printed circuit board 20 is clamped between the housing 19 and the housing cover 27. Then, the washer 29 and the nut 30 are disposed on the housing 19, and thereby the lever switch with the display device is completed.

For the lever switch with the display device of the present invention as configured in the above-described manner, an operation of the lever 18 causes the shaft 14 to tilt about the tilting shaft 17, and a light-shielding piece 14c formed in the lower part of the shaft 14 shields a light between a light-receiving element and a light-emitting element of the photo-interrupter 23, so that the tilting motion of the lever 18 is detected by the photo-interrupter 23. At this point, it is also possible to change display of the OLED 10 along with the operation of the lever 18. Moreover, by pressing the display unit 12, the rubber cover 8 disposed below the OLED 10 presses the movable contactor 5 to bring it in contact with the fixed contactor 2a disposed on the printed circuit board 2, so that an electric circuit is conducted. Then, by releasing the operation of the lever 18, the sleeve 26 is pushed back by a spring force of the coil spring 25, and the lever 18 returns to its upright position. In addition, in the case where the lever switch is mounted to a panel (not shown), the lever switch is inserted into a mounting hole provided in the panel, and the nut 30 is fastened in the mounting direction from the backside of the panel, thereby a flange 19e of the housing 19 and the washer 29 fixingly interpose the panel.

The display unit 12 is allowed for various displays by the transmission of data of pictures or texts to the OLED 10, wherein the data is transmitted from a control board (not shown) external to the lever switch via the connector 22. By cooperating the data transmission with switching on/off of the photo-interrupter 23 for detecting the tilting motion of the lever 18 or with switching on/off of the movable contactor 5 and the fixed contactor 2a accompanied with the pressing operation of the display unit 12, the display is also enabled to change along with the tilting operation of the lever 18 or the pressing operation of the display unit 12. For example, when the tilting direction of the lever 18 is indicated by displaying an upward or downward arrow on the display unit 12, and in accordance with the display an operator operates the lever 18 in the direction indicated by the arrow, the lever 18 is tilted to shield the light between the light-receiving element and light-emitting element of the photo-interrupter 23 to turn on the photo-interrupter 23. Along therewith, a signal for initiating the data transmission is sent to the control board external to the lever switch, thereby data of a picture or text to be displayed next is transmitted from the control board to the OLED 10 and the display is switched over. Similarly in the case where the display unit 12 is pressed, when the movable contactor 5 and the fixed contactor 2a are switched on, a signal for initiating the data transmission is sent to the control board along therewith, and the display on the display unit 12 is switched over.

As has been described, since the lever switch with the display device illustrated in this embodiment is configured to provide the lever 18 that can be tiltably operated with the OLED 10, it is characterized in that the lever switch per se makes various displays possible and can change the display in cooperation with the operation of the lever 18, resulting in the improvement of visibility.

In addition, since the display unit 12 is allowed for the pressing operation, a single lever switch can perform a composite operation of tilting and pressing.

While the display unit in this embodiment is the OLED, it may be a liquid crystal display device, an electronic paper or the like. While the lever has a structure in which a two-directional tilting operation is possible, a four- or all-directional tilting motion may be made possible by modifying the shapes of the tilting shaft and the bearing section. While the shape of the operating unit of the lever is generally spherical, it may be cylindrical or the like. The contact mechanism within the lever may be a switch element such as a tactile switch, and the switch element may be eliminated if the pressing operation is not required. In addition, while mounting means to the panel is the mounting with the nut, a wide variety of methods are contemplated including instant mounting by forming a spring by resin or the like in the housing.

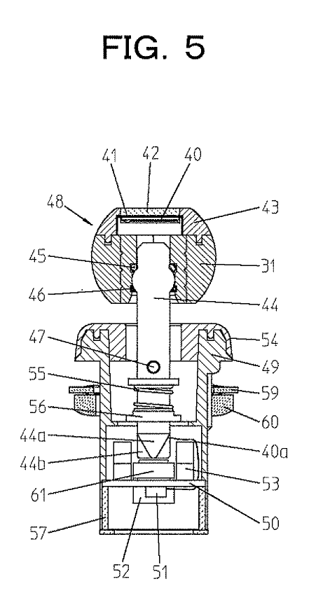

FIG. 5 is a cross-sectional view of a main part of the lever switch with the display device showing a second embodiment of the present invention. In this embodiment, the tilting operation and the pressing operation of a lever 48 are possible, and a tilting shaft 47 is disposed in a housing 49 movably in the vertical direction, thereby the lever 48 as a whole is lowered by the pressing operation. In the lower part of a shaft 44, a pressing piece 44a and a light-shielding piece 44b are formed in an opposing relationship, wherein when the lever 48 is tilted, the tilting motion of the lever 48 is detected by the light-shielding piece 44b shielding the light between the light-receiving element and the light-emitting element of the photo-interrupter 53, and when the lever 48 is pressed, the pressing piece 44a presses a tactile switch 61 that is implemented on a printed circuit board 50 arranged in the lower part of a housing 49, so that an electric circuit is conducted. The display on a display unit 42 can also be changed along with the operation of the lever, as with the first embodiment. This embodiment can also be modified in a similar manner with the first embodiment, and a wide variety of methods are contemplated.

The present invention should not be limited to the embodiments described above, and a number of variations are possible on the basis of the sprit of the present invention. These variations should not be excluded from the scope of the present invention.

### INDUSTRIAL APPLICABILITY

The lever switch with the display device according to the present invention can be utilized as a lever switch provided with a display device that enables various displays.

What is claimed is:

1. A lever switch with a display device including a lever tiltably disposed in a housing and detection means for detecting a tilting motion of the lever arranged in the housing, wherein the lever is provided with a display unit and a display device is provided below the display unit.

2. The lever switch with the display device according to claim 1, wherein the display device is an organic light-emitting device.

3. The lever switch with the display device according to claim 1, wherein display of the display unit changes along with the tilting motion of the lever.

4. The lever switch with the display device according to claim 1, wherein the display unit is disposed in the lever via a resilient member, the display unit is allowed for a pressing operation, and a contact mechanism operated along with the pressing operation is disposed below the display device.

5. The lever switch with the display device according to claim 4, wherein display of the display unit changes along with a pressing motion of the display unit.

6. The lever switch with the display device according to claim 1, wherein the lever is disposed in the housing in a manner that a tilting shaft is movable in the vertical direction, the lever as a whole is allowed for the pressing operation, and the contact mechanism operated along with the pressing operation is disposed in the lower part of the housing.

7. The lever switch with the display device according to claim 6, wherein display of the display unit changes along with the pressing motion of the lever.
